(19) United States
(12) Patent Application Publication
(10) Pub. No.: US 2008/0263594 A1
(43) Pub. Date: Oct. 23, 2008

(54) Schedule of a Broadcast Management System

(75) Inventor: Robert Rutherford, New South Wales (AU)

Correspondence Address: SNELL & WILMER LLP (OC), 600 ANTON BOULEVARD, SUITE 1400, COSTA MESA, CA, 92626, US

(73) Assignee: RUZZ TV PTY LTD, Gladesville, NSW (AU)

(21) Appl. No.: 11/909,965

(22) PCT Filed: Apr. 6, 2006
(86) PCT No.: PCT/AU2006/000458

§ 371 Date: Sep. 27, 2007

(30) Foreign Application Priority Data
Apr. 6, 2005 (AU) 2005901692

(51) Int. Cl. G06F 3/00

(52) U.S. Cl. 725/39

(57) ABSTRACT

The invention concerns schedules of a broadcast management system. In particular but not limited to, the invention concerns the managing of electronic schedules by a TV broadcaster having one or more television channels. The invention also concerns methods for creating, managing and broadcasting schedules database by a broadcast management system. The invention further concerns a datastore, a software application program and a computer system for implementing these methods. The schedule is comprised of events (100) and sub-events (110) each having associated essences (102 106 112) and source, wherein inheritance is implemented in a top-down manner so that the sub-event (110) inherits from the parent (100) the essences (102 106) or stores that it does not already have. The inheritance is governed by the types essence of the essence type that the source supports. By representing the schedule in a way that captures both events and essences in a hierarchical structure, the schedule contains sufficient information suitable for use by multiple components of the broadcast management infrastructure. This helps to reduce the need for ad-hoc integration in broadcast components. The hierarchical structure also allows for the capture of schedule information in a natural, top-down fashion that also allows for inheritance.

### TECHNICAL FIELD

The invention concerns schedules of a broadcast management system. In particular but not limited to, the invention concerns the managing of electronic schedules by a TV broadcaster having one or more television channels. The invention also concerns methods for creating, managing and broadcasting schedules by a broadcast management system. The invention further concerns a datastore, a software application program and a computer system for implementing these methods.

### BACKGROUND ART

Television broadcasters implement management systems to co-ordinate the scheduling of events. If scheduled correctly, the events will cause the continuous playout of media on one or more channels of the broadcaster.

Modern television broadcasters are faced with significant complexity introduced by:
digital TV, including high definition and interactive television (iTV)
dynamic schedule management (EPG/EIT), and the effect on devices like PVRs
pay-per-view/near video-on-demand
digital asset management (DAM) including cataloguing and browse functionality
convergence of computers and TV
advertising sales, and
billing.

Each of these services are often delivered by different components of a broadcaster's management system. In an attempt to integrate these components broadcasters build ad-hoc software changes. Such integration projects result in “spaghetti” integration as shown in FIG. 12. Ad-hoc custom solutions become increasingly difficult to manage effectively especially as component interconnections grow.

### SUMMARY OF THE INVENTION

In a first aspect the invention provides a method of creating a schedule of events for use by a broadcast management system, the method comprising the steps of:

creating an entry for an event of the schedule and associating with the event a first essence and/or a first source of the event;

creating an entry for a sub-event of the schedule and associating the sub-event with the event as a child of the event, and if required, associating with the sub-event a second essence and/or a second source of the sub-event;

if the second essence is not the same type as the first essence or no second essence is associated with the sub-event, the sub-event inheriting the first essence; and

if the second source does not support the same essence type as the first source or no second source is associated with the sub-event, the sub-event inheriting the first source.

By representing the schedule in a way that captures both events and essences in a hierarchical structure, the schedule contains sufficient information suitable for use by multiple components of the broadcast management infrastructure. This helps to reduce the need for ad-hoc integration in broadcast components. The hierarchical structure also allows for the capture of schedule information in a natural, top-down fashion that also allows for inheritance.

For any event in a schedule multiple essences may be associated with it. An essence is any single unit of content within a facility, such as a video tape or a subtitle file. The essence type defines the nature of the content. For example, for an episode of a television show the following types of essences are played to air:
a video and audio (VA) type essence for each segment of the episode
a video and audio (VA) type essence for each commercial
electronic program guide (EPG) type essence for the episode, and
subtitle type essence.

The event is any component of a schedule, such as a transfer event or a playing to air event. The events may have one or more associated locations, such as source or destination locations. A play to air event has a source location identifying where essences for playing to air should be stored. The transfer event also has a destination location where essences for the events are to be transferred to. Each location will support certain essence types. For example, a EPG server may only be capable of storing EPG type essences and a video server may be capable of storing video and audio type (VA) essences and video over type (VO) essences.

The first event may be a sub component of a schedule of play to air events. The first essence may be inherited by the sub-event by playing the first essence to air when the sub-event is played to air.

The first event may be a sub component of a schedule of transfer events. The first essence may be inherited by the sub-event by transferring the first essence when the transfer of the sub-event is performed.

The first source may be inherited by the sub-event by using that first source as the source for essences associated with the sub-event which are a type supported by the first source.

The essence type of an essence may be defined in the metadata associated with the essence. Alternatively, the method may comprise associating a track with the essence that defines the essence type of the essence. By associating a further object to an essence to capture the type of the essence, conducting queries on the schedule based on essence types can be performed more efficiently.

The event may be a playout event, record event or may be a container event.

The associating step may include creating in the entry for the event or sub-event a link to the essence, such as recording an identifier for the essence with the event or storing a pointer to the essence in the event.

The method may further comprise associating with the essence a store where the essence is stored. For example, the store may be a video server or a video cart. The method may further comprise associating as a child of the store a sub-store if the sub-store is stored in the store, such as a video file (child) on a video server (parent).

The method may further comprise associating a port to the source through which an essence associated with the event or sub-events may by sourced. For example, a port may be a physical connection or the available bandwidth. The port may support one or more essence types to be sourced using that port.

The method may further comprise the step of creating a timing relationship between the event and sub-event, such as both starting at the same time or the sub-event starting a certain period of time offset from the start of the event.

The method may further comprise the step of associating with the event a first destination and associating with the sub-event a destination of the sub-event, and if the sub-event does not have an associated destination that supports the same essence type as the first destination, the sub-event inheriting the first destination. The first destination may be inherited by the sub-event by using that first destination as the destination for essences associated with the sub-event that are a type supported by the first destination.

The method may further comprise associating as a child to the sub-event a further sub-event, wherein the sub-event behaves as the first (parent) event to the further sub-event.

The method may further comprise linking further essences to the first event.

The database can be modified at anytime to create new event types and essence types.

The method may further comprise presenting the schedule in a visual format on a display unit of the broadcast management system.

The visual format may display the schedule as a hierarchical tree of parent and child events. The visual format may also show any one or more of the links between the events and essences, the source and destination of events, the timing links between events and the tracks of the essences.

Alternatively, the visual format may be grid based having duration along one axis and essence type along the other, every location on the grid being a unique combination of time and essence. This grid view allows the hierarchical structure of events to be turned into low-level device schedules and commands, making the schedule a practical way of providing real-time control of a broadcast operation to components of the broadcast management system.

The method may further comprise accessing the schedule on the database by a component of the broadcast management system using an interface. The method may further comprise using the interface to extract from the schedule on the datastore the schedule information specific to that component. The interfacing allows multiple components from different vendors to simultaneously access the database.

In a second aspect the invention provides a datastore for storing a schedule of events for use by a broadcast management system, the datastore comprising:

an entry for an event of the schedule including an associated first essence and/or a first source of the event;

an entry for a sub-event of the schedule that is associated with the event as a child of the event, and if required including an associated second essence and/or second source of the sub-event;

wherein if second essence is not the same type as the first essence or no second essence is associated with the sub-event, the entry of the sub-event including the first essence by inheritance from the event; and if the second source does not support the same essence type as the first source or no second source is associated with the sub-event, the entry of the sub-event including the first source by inheritance from the event.

In a further aspect, the invention provides a method of broadcasting a schedule by a broadcast management system, the method comprising the steps of:

creating the schedule according to the method of any one of claims 1 to 23 and storing it in a datastore; and

providing an interface to the datastore to enable a device of the broadcast management system to access the datastore so that the device can extract from the schedule the event and sub-event required by the device to broadcast the schedule.

The method may further comprise accessing the database though an interface of the component. The method may further comprise the component extracting the information it needs from the schedule by examining information associated with the essence type that its operations are concerned with. For example, the EPG system will extract information related to the EPG track only.

The method may further comprise accessing the database using a graphical user interface (GUI). The GUI may be adapted for the specific needs of the different components of the broadcast management system. The GUI may also allow complex queries to be conducted on the database. In this way, a single user interface can enable the simultaneous real-time control of multiple playout automation systems, including those from different vendors.

The method of managing a schedule may be used to simulate the broadcast management system.

In a further aspect of the invention, the invention provides a software application program installed on a computer system to perform any one of the methods described above. In yet a further aspect, the invention provides a computer system having processing means and a datastore, wherein software is installed on the computer system to enable the processing means to operate to enable the creation of a schedule according to the method described and to store the schedule on the datastore.

### BRIEF DESCRIPTION OF THE DRAWINGS

An embodiment of the invention will now be described with reference to the accompanying drawings, in which:

FIG. 1 is a schematic diagram of the basic components of the database;

FIG. 2 is a schematic diagram of the schema of the database for representing the schedules;

FIG. 3 is a schematic diagram of an Essence object type;

FIG. 4 is a schematic diagram of an Essence Store object type;

FIG. 5 is a schematic diagram of a Port object type;

FIG. 6 is a schematic diagram of an Event object type;

FIG. 7 is a schematic diagram of a Track object type;

FIG. 8 is a schematic diagram of part of a schedule having child events that inherit tracks from parent events;

FIG. 9 is a diagram showing how management software is deployed by a broadcaster;

FIG. 10 is a hierarchical representation of a schedule where one Event has been linked in;

FIG. 11 is a grid view of the schedule of FIG. 10; and

FIG. 12 shows the components and interconnections of an example broadcaster's management system (prior art).

### BEST MODE OF THE INVENTION

The invention provides a way to create and manage broadcast schedules, assets and storage devices in a single, highly-linked database structure that is continuously updated in real-time.

The design and implementation of a software application embodying the invention will now be described. The software consists of three layers:
the core database which provides a generic method of representing objects, their attributes and the links between them;
the object model provides a way of representing all the workflow components that go together to make up a broadcaster's operation, and
the device interfaces which provide a mechanism to update the object model on a continuous, real-time basis.

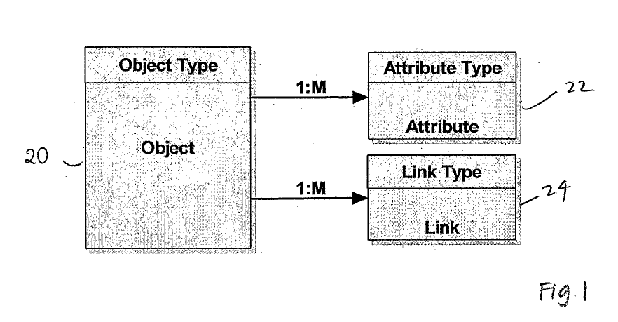

The core database is built on a traditional relational database platform. The database is based on the concepts of objects 20, attributes 22 and links 24 as shown in FIG. 1.

An Object 20 represents anything which can be conceptualised as a distinct, self-contained “thing”. For example, an Object 20 might be a physical video tape, it might be a vision switcher, it might be a file on a file server, or it might be something that is more conceptual like an event within a playout schedule. All objects have a name and a “type”, which is called the ObjectType. The ObjectType defines what attributes the Object 20 has, and how it is related to other Objects 20 within the context (what links it has), as described below.

An Attribute 22 is used to represent some property or value of an Object 20. For example, for an Object 20 which is a file, it might have Attributes 22 of Size and Owner. Attributes 22 belong to an Object 20 and have a “type” which is called the AttributeType. The AttributeType defines the Attribute 22 name and also what values the Attribute 22 can take. For example, is it a number or a string, does it have a minimum/maximum value?

A Link 24 defines a relationship between one Object 20 and another Object 20. The Objects 20 that are related can be of the same or different ObjectType. The relationship defined by a Link 24 can be one-to-one, one-to-many or many-to-one. Each Link 24 has a “type” which is called the LinkType 32. The LinkType 32 defines which ObjectTypes 30 the link applies to. A Link 24 can also have Attributes 22, just like Objects 20.

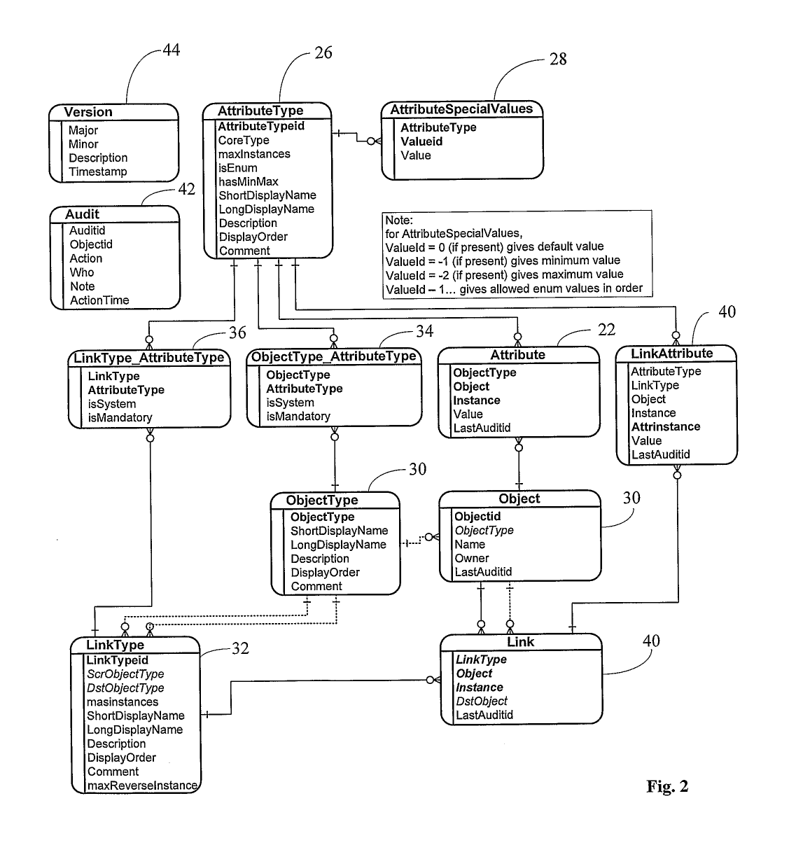

A database schema showing the relationship between these concepts is shown in FIG. 2. This is the database schema for an example software application program Victor (herein Victor) that will now be described.

The AttributeType table 26 defines all the different Attributes 22. This AttributeType table 26 is normally created during system configuration/installation but new entries can be added while the system is “live”. Some of the key columns in this table are:
AttributeTypeId. Unique identifier for this AttributeType. This is the key for lookups into this table.
CoreType. What is the “base” type of this attribute. Supported values include “Integer”, “String”, “Text”, “TOD” (Time of Day), “TDelta” (time difference) and “Bool” (Boolean value).
maxInstances. How many instances of this Attribute can each individual Object have? In most cases this is set to 1, but there are times when it makes sense to have multiple instances. For example you could have a list of users who are allowed to access a particular device. A value of 0 is used to represent “infinity”.
isEnum. Is this attribute restricted to a certain set of allowed (enumerated) values? This can apply to all CoreTypes—for example you can specify that an Integer attribute can only have the values 0, 1, 3, 5, 7, 11, 13, or that at String attribute can only have the values “Red”, “Green” and “Blue”.
hasMinMax. Does the attribute have a minimum and maximum allowed value? Mutually exclusive with isEnum.
ShortDisplayName, LongDisplayName, Description, DisplayOrder. These are used for displaying information about the attribute in log messages and in user interfaces. They do not affect the core operation of Victor.

All the restrictions and limitations described here are implemented/enforced by the Victor Application Program Interface library. Alternatively, they could be automatically enforced by the underlying database storage engine (MySQL) by using Table Constraints and Stored Procedures/Triggers (etc).

The AttributeSpecialValues Table 28 defines the Default value for each Attribute defined in the AttributeType table 26. For Attributes which have the hasMinMax or isEnum set to true, this table also defines the ranges of allowed values (min, max and enum values).

The ObjectType table 30 describes all the different Objects. This table 30 is normally created during system configuration/installation but new entries can be added while the system is “live”. The key column for the ObjectType table 30 is ObjectType. This is a unique identifier which is the key for lookups into this table. The table 30 also contains only the ShortDisplayName, LongDisplayName, Description, and DisplayOrder columns—which are used for displaying information about the ObjectType in log messages and in user interfaces. They do not affect the core operation of Victor.

The LinkType table 32 describes all the different Links between Objects. The LinkType table 32 is normally created during system configuration/installation but new entries can be added while the system is “live”. Some of the key columns in this table 32 are:
LinkTypeId. Unique identifier for this LinkType. This is the key for lookups into this table
SrcObjectType. What ObjectType acts as the source for this link? This is a foreign key into the ObjectType table.
DstObjectType. What ObjectType acts as the destination for this link? This is also a foreign key into the ObjectType table.
maxInstances. maxReverseInstances. These two columns together define the ordinality of this link, as shown in the table below.
ShortDisplayName, LongDisplayName, Description, DisplayOrder. These are used for displaying information about the link in log messages and in user interfaces. They do not affect the core operation of Victor.
   The following table shows the ordinality of the different types of Links:

| maxInstances | maxReverseInstances | “Ordinality” |
|---|---|---|
| 1 | 1 | One-to-one |
| 1 | 0 (infinity) | Many-to-one |
| 0 (infinity) | 1 | One-to-many |
| 0 (infinity) | 0 (infinity) | Many-to-many |

The ObjectType_AttributeType table 34 describes which ObjectTypes can have which Attributes. This table 34 is normally created during system configuration/installation but new entries can be added while the system is “live”.

Some of the main key columns in this table are:
ObjectType, AttributeType. These columns together provide the key for lookups into this table. If there is a row in this table for a particular ObjectType/AttributeType pair, then objects of that ObjectType are permitted to have attributes of the specified AttributeType.
isSystem. This Boolean value specifies whether this ObjectType/AttributeType pair is required for the core (internal) functioning of Victor. If this is false, then this AttributeType is used only for user/site-specific purposes.
isMandatory. This Boolean value specifies whether at least one instance of an attribute of this AttributeType is required for every object of the corresponding ObjectType.

The LinkType_AttributeType table 36 performs the same function as the ObjectType_AttributeType 34 table only it applies to Link Attributes rather than Object Attributes.

The Object table 38 contains a row for every Object in the live system. Unlike the previous tables, this table is a dynamic table which is constantly changing as Objects within Victor pass through their lifecycle of creation, use and deletion.

The main columns in this table are:
ObjectId. This column is the key for lookups into this table and is automatically assigned a new value (auto-increment) whenever a new Object is created.
ObjectType. This is the type of the object and is a foreign key reference into the ObjectType table.
Name. The “name” of the object. This can be a meaningful name for the Object (as defined by the user or some external system), or it can be an internally generated value based on the ObjectId. The only requirement is that the ObjectType+Name combination is unique (you can't have two Objects with the same ObjectType and the same Name). This uniqueness constraint is enforced by the underlying database.
Owner. This allows each Object to be “owned” by a different user. This allows fine-grained permission controls to be implemented.
LastAuditId. This column contains the id (from the Audit table) of the last change that affected this Object. This allows database clients to easily identify which Objects have been recently changed, and by whom.

The Attribute table 38 contains a row for every Attribute defined within the system. This is another “live” table.

The main columns in this table are:
Attribute Type. This is a foreign key reference into the AttributeType table which identifies the type of attribute.
Object. This is a foreign key reference into the Object table which identifies the Object which has this attribute.
Instance. This allows for an Object to have multiple instances of an attribute of the same AttributeType. The Attribute, Object and Instance together form the key for lookups into this table.
Value. This column contains the value of this attribute. All attribute values are stored as strings (text) and converted to/from the corresponding CoreType by the Victor API.

The Link table 40 contains a row for every Link defined within the system. This is another “live” table.

The main columns in this table are:
LinkType. This is the type of the link and is a foreign key reference into the LinkType table.
Object. This is the object which is the source for the Link. It is a foreign key reference into the Object table.
Instance. This allows for an Object to have multiple Links of the same type. This is automatically assigned a new value (auto-increment) whenever a new Link is created. Unlike Attribute instances, Link instances are globally unique across all Links. The Link Type, Object and Instance together define the key for lookups into this table (although technically the Instance would be sufficient on its own).
DstObject. This is the object which is the destination for the Link. It is also a foreign key into the Object table.
LastAuditId. Like the similar column in the Object table, this contains the id (from the Audit table) of the last change that affected this Link. This allows database clients to easily identify which Links have been recently changed, and by whom.

The LinkAttribute table 40 is the equivalent of the Attribute table 28 only for Link attributes.

The key for lookups into this table is AttriubteType+(LinkType+Object+Instance)+AttrInstance where (LinkType+Object+Instance) is the foreign key reference into the Link table and AttrInstance is the equivalent of Instance in the AttributeTable.

The Application Program Interface (API) creates an entry in the table for every change (write) to the database. This provides a full history of all updates for logging/faultfinding and is recorded in the Audit table 42. Each change is also allocated a unique AuditId. This is as part of the Notification mechanism which is described below.

Victor also maintains a Version Table 44. There is a row in this table for each different Version of the Core Database that has been installed on this particular system. This provides a historical record of what versions have been installed, and allows the ReviseDB program to automatically update tables (etc) in the rare situation where this may be required.

The above database schema can be applied to the operation of broadcast operations, encapsulating essences, business processes (workflows) and technical operations in a single schedule. Victor supports the following Object Types:
Essences
Essence Stores
Ports
Events, and
Track.
   Each of these will now be discussed in detail.

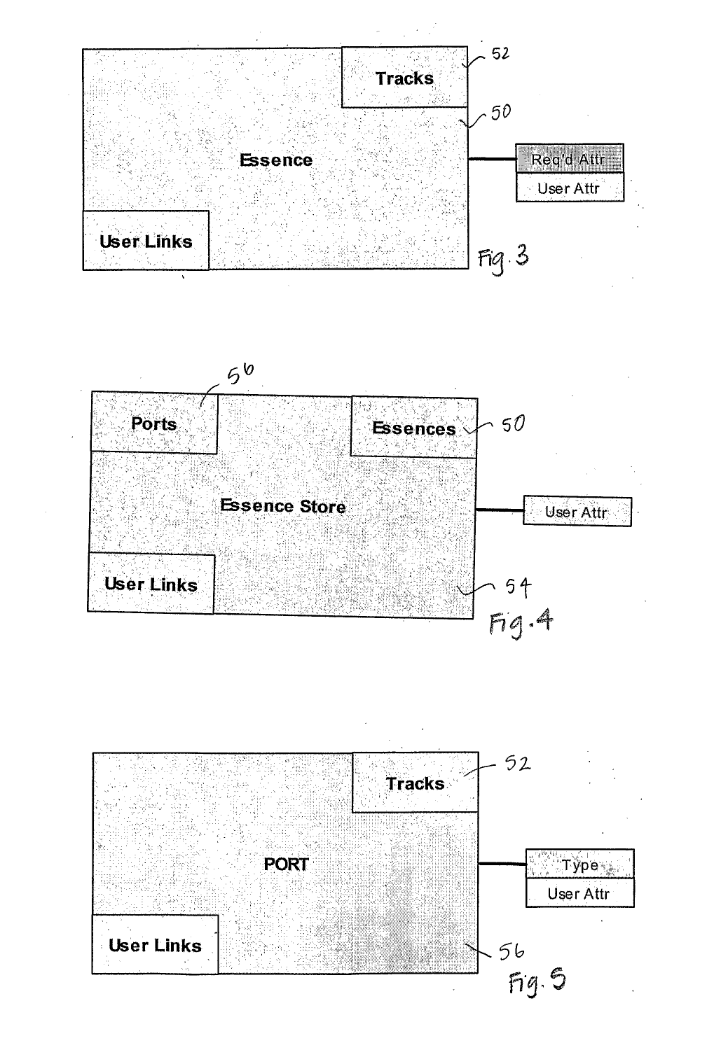

A schematic diagram of an Essence 50 is shown in FIG. 3. An Essence 50 is a single unit of “content” within the facility. An Essence 50 can also be a device or schedule.

Some examples of Essences 50 are a programme on a video tape, a file on a video server, a subtitle file on a file server.

There can be multiple instances of the same Essence 50 within a facility, as long they all represent, or relate to, the exact same object.

Essences have links to the Tracks 52 associated with them that defines the type of essence that it is associated with. For example, a file on a video server might have Video, Audio, and Subtitle Tracks. A file on a server might just have a Subtitle Track.

Essences can exist in hierarchical (parent/child) structures, with one Essence containing links to child Essences. For example, a movie might be represented as a single Essence with a child Essence for each segment within that movie even though the segment does not exist on a separate file.

A schematic diagram of an EssenceStore 54 is shown in FIG. 4. An EssenceStore 54, as its name implies, is something that stores or contains Essences 50. Some typical EssenceStores 54 include:
A video server or archive (EssenceStore 54) which contains many different video clips (Essences 50)
A video tape (EssenceStore 54) which contains several different commercials (Essences 50)
A robotic cart machine like a Flexicart (EssenceStore 54) which contains many different tapes (nested EssenceStores 54) which themselves contain commercials (Essences 50)

As can be seen in these examples, EssenceStores 54 can also be arranged in hierarchical (parent/child) structures, with one EssenceStore 54 containing another. This can be used to represent everything from tapes within a robotic cart machine, to directories within a file server.

An EssenceStore 54 has a link to all the Essences 50 contained within it.

An EssenceStore 54 has one or more Ports 56 through which the Essence 50 can be transferred.

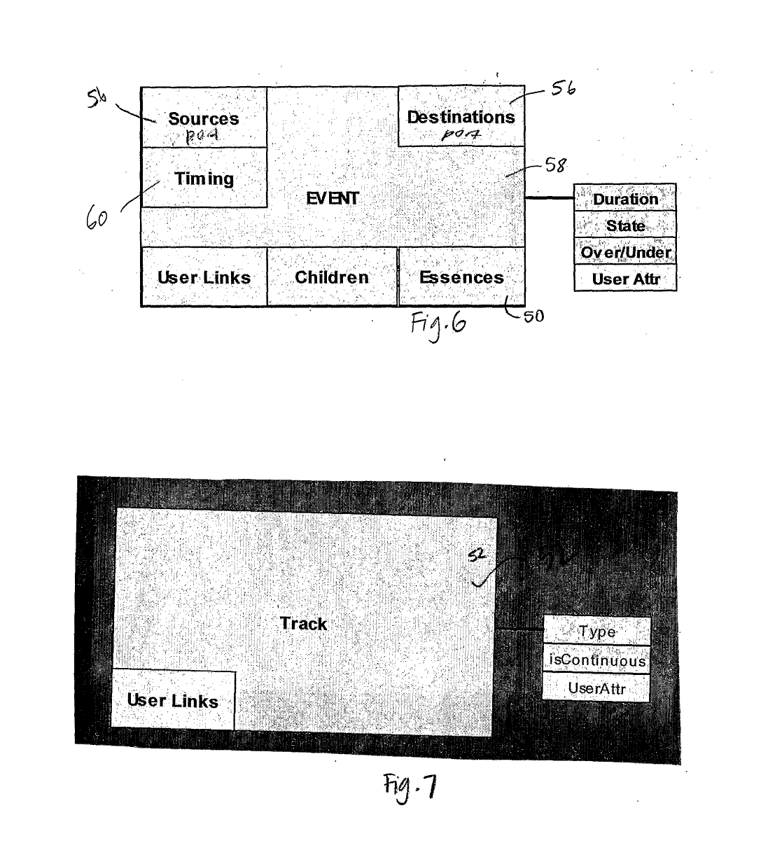

A schematic diagram of a Port 56 is shown in FIG. 5. A Port 56 represents a connection for transferring an Essence 50 into or out of an EssenceStore 54. Each EssenceStore 54 can be configured with a certain number of transfer Ports 56. A Port 56 may be reserved for high priority (urgent) transfers.

Ports can be input, output or bidirectional.

Ports have a Capacity which represents the number of simultaneous transfers that are possible through the given Port 56.

In some cases Ports 56 are a fairly abstract concept which just represent the available bandwidth of a network device, while in other cases Ports 56 correspond directly to physical connections such as video or audio connectors.

A schematic diagram of an Event 58 is shown in FIG. 6. An Event 58 is used to represent the transfer of an Essence 50 from one location to another. It is the smallest component (building block) of a schedule.

An Event 58 can have Links to one or more Essences 50 which are associated with the Event 58. This is known as the Event's Essence Link.

An Event 58 can have a Link to a source and/or destination EssenceStore 54. These are known as the Event's SourceStore Link and DestinationStore Link respectively.

An Event 58 has a Nominal Start Time. This can either be an absolute (fixed) time but in most cases it is derived from the event's Timing Link 60. The Timing Link 60 is a link to another Event 58 which controls when this Event 58 starts. The Timing Link 58 has attributes to specify the timing relationship between the events (Start-Start, Start-Finish, Finish-Start and Finish-Finish), and any offset that is to be applied. So, for example, if this Event 58 has a Finish-Start Link to another event which starts at 18:00:00 and has a duration of 15 minutes, then this Event has a start time of 18:15:00. Or if this Event as a Start-Start Link to another event that starts at 06:00:00, with an offset of 5 seconds, then this Event 58 starts at 06:00:05.

An Event 58 has a Nominal Duration. By default this is derived from the longest duration of any associated (linked) Essence 50 however this can be overridden, for example if only part of the Essence 50 is required.

Once an Event 58 has had its resources assigned, it also has links to the actual Ports 56 through which it will operate. These are known as the Event's SourcePort Link and DestinationPort Link respectively.

Events 58 can be arranged in hierarchical (parent/child) structures with one Event 58 containing one or more other Events 58. This hierarchical structure represents the logical relationship between Events 58 and is quite separate/distinct from the timing (start/offset) relationship between events which is defined by the Timing Link 60.

There are a few common types of Events 58 which help demonstrate how this is used in practice:
Transfer Events are Events 58 which represent the transfer of an Essence 50 from one EssenceStore 54 to another. They have an Essence Link to represent the Essence 50 to be transferred and SourceStore and DestinationStore Links to represent where it is to be transferred from/to. They have a CompleteBy attribute that specifies by when the transfer has to be completed.
Playout Events are events which represent the play to air of a particular Essence 50. Their key parameters are the Essence Link and DestinationPort and Timing Link. The SourceStore and SourcePort can be specified or can be calculated during resource assignment.
Record Events which represent the record of a particular Essence 50. Their key parameters are the Essence Link and SourcePort and Timing Link 60 (or absolute start time). The DestinationStore and DestinationPort can be specified or can be calculated during resource assignment.
Container Events which represent a container for a group of subsidiary (child) Events 58—for example an entire movie with all the commercials and other content embedded in it. Container Events may be pure Containers which only contain child Events, or they may have Essences 50 or Source or Destination Ports which are inherited by the Events below.

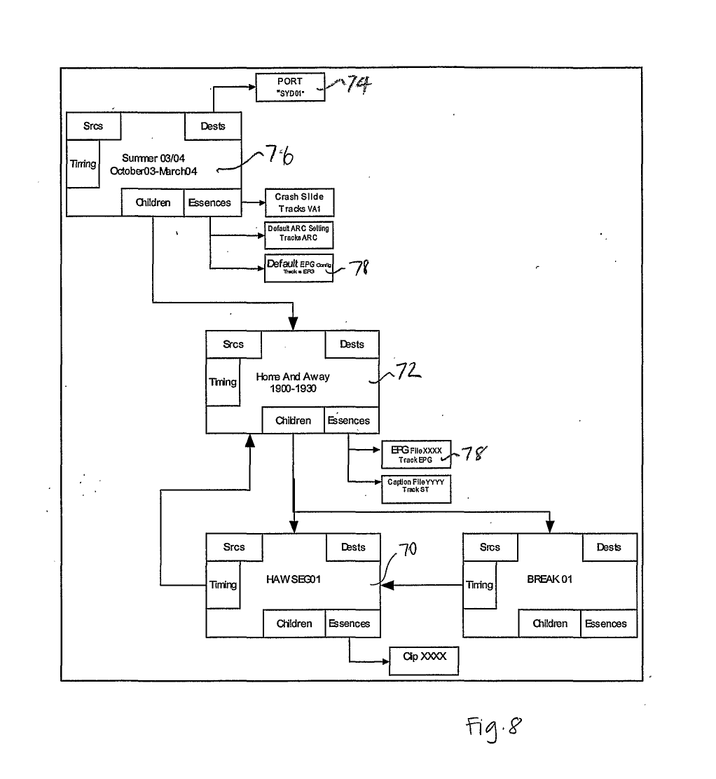

A schematic diagram of a Track 52 is shown in FIG. 7. A Track 52 is an object which represents a level or layer or type of information within a facility (Essence). A particular object within the facility is capable of providing (sourcing), modifying (processing) or accepting (receiving) information on one or more Tracks 52. A Track 52 may be physical or virtual.

A Track 52 is a key concept that can be applied in many different ways. Some examples of some typical Tracks:
Video and Audio tracks (VA) are self-evident. However note that it may make sense within a particular facility to define a single logical Track 52 as “Video plus 2 Audio”. This would apply in the case where all these 3 physical tracks were always bundled together for recording, routing and playout. VA tracks are sourced and accepted by VTRs and Video Servers and are processed by switchers and other devices.
A Browse Track represents a lower-quality representation of video and audio that is stored on a file server and is suitable for desktop browsing.
A Video Over (VO) track represents a layer of video which will be keyed over another video source. VO tracks are typically sourced by Character Generators of one sort or another and have switchers as destinations.
An Audio Over (AO) track is analogous to a Video Over Track—except for Audio. It typically represents voice overs.
A Subtitle Track specifies the closed caption (subtitle) information associated with a program or commercial. It can be physically embedded in the video or can be carried as a data file.
An Electronic Program Guide (EPG) Track represents the program synopsis information associated with a program (title, description, genre, classification etc). This information is generally carried as metadata in a file or database.
An iTV track represents the information required to support an Interactive Application associated with a particular program.

One of the key elements of the Victor representation of Events and Schedules is the concept of Inheritance of Links and Attributes from Parent to Child Events.

Inheritance means that if a particular Child Event does not have a particular Link or Attribute that is required for its correct function, then it is borrowed from its Parent (or its Parent's Parent.)

An example of Inheritance will now be described with reference to FIG. 8. Consider the first segment of Home and Away, the Event called “HAWSEG01” 70. This event 70 does not specify a Destination Port, nor does its Parent 72, so its Destination Port 74 is inherited all the way back from the master (root) event “Summer 03/04” 76. So we say that the Destination Port for HAWSEG01 70 is “SYD01” 74, by inheritance from above.

Similarly, we can find the EPG data 78 for this program segment by inheritance from its immediate Parent event 72. So the EPG data for HAWSEG01 70 is provided by EPG file XXXX 78 by inheritance. However if the Parent 72 did not have any EPG data, then the EPG data would instead be supplied by the Default EPG 78 data associated with the master (root) event 76.

Inheritance is limited and controlled by the use of the Track concept. Inheritance only applies among objects which provide or supply the same Track.

Inheritance and the hierarchical Event structure provide a way of specifying/describing schedule information in a natural, top-down fashion. The schedule can be “flatten” to an actual sequence of low-level events/commands that a particular device of the broadcast management system must execute.

This is again based on Tracks. A particular device interface (Port) has a list of Tracks associated with it. In order to find the list of all events (commands) that that device must execute, it is simply a matter of finding all events which have that Port/Track associated with them, and applying inheritance to ensure that this Track has not been overridden by something at a lower level in the event hierarchy. This generates a list of commands which can then be issued to the actual device.

DestinationPort Inheritance provides a single place for control/change router output a service is targeted for.

The timing of the commands is controlled by the Event Timing Link which is managed independently of the Event's hierarchical (Parent/Child) relationships.

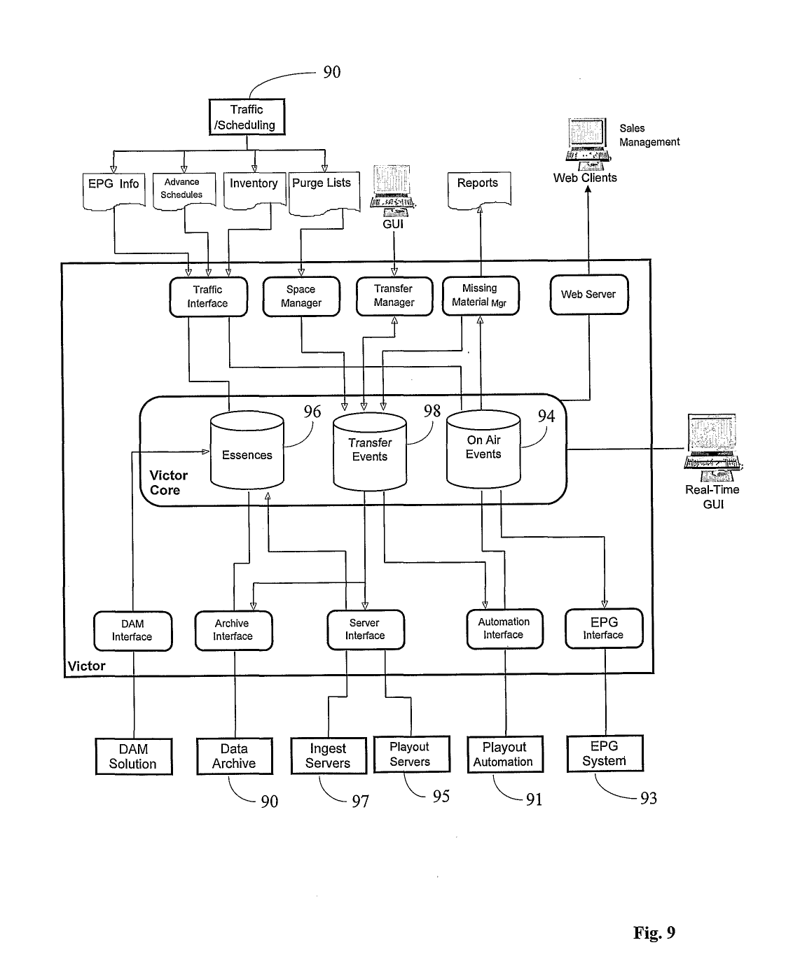

FIG. 9 is a block diagram showing how Victor is deployed by this imaginary broadcaster to provide a playout and material management solution. The following inputs are provided:
Traffic/Scheduling system 90 provides an Advanced Schedule and Inventory that indicates the transmission requirements over the next few days. This is used to populate the OnAir Event Database 94 and Essence Database 96.
EPG Information from the Traffic/Scheduling system 90 is used to populate the Essence 96 and Event 94, 98 Databases.
The current contents of the Archive and Video Servers are read by Victor and used to update the EsesnceStore Database.
The current Playout Automation 100 schedule is read and used to update/revise the Event Databases 94 and 98.
   Following this input, Victor:
Schedules are automatically loaded into Playout Automation 100 twelve hours in advance. Any late changes which come from Traffic/Scheduling 90 are automatically inserted into Playout Automation 100 provided they are not within 1 hour of on-air.
EPG information is automatically loaded into the EPG System 102. The EPG System is automatically updated/triggered as program start times change in Playout Automation.
Any material which is required for on-air and which is missing from the Playout Servers 108 is notified to the operator, and if it can be found in the Ingest Servers 104 or Archive 106 it is automatically transferred to the Playout Servers 108.
Any material which appears on the Ingest Servers 104 is automatically copied to the Archive 106.
If the Playout Servers 108 are getting full then material is automatically deleted based on a combination of: Least Recently Used (LRU) with a check for any future requirements for the material.
The Traffic/Scheduling system 90 is updated as inventory is received and as events are played to air.

A range of users may use Victor, and these include:
OnAir presentation operators to edit/update the OnAir playlists across multiple Playout Automation systems in an intuitive and efficient way
Ingest operator that check for Missing Material and prioritise their workflow
Support/Supervisory staff to check the status of EPG synchronisation and server/archive capacity/fullness (etc)
Traffic Operator
Transmission supervisor
Maintenance/support technician
Sales staff can use Victor to check which commercials have been ingested and therefore available for late sales.

The following description provides a sample workflow. Victor receives a file from the Traffic/Scheduling system 90 which contains the schedule for the next 7 days. The next 24 hours are “finalised” but the rest of the schedule (days 2-7) is provisional and has place-holders or missing spots and programmes.

The schedule received from Traffic 90 is a simple flat file with a line per event in a fixed format.

For each event in the schedule, one or more Event records are updated or created as below:
If the event is a Comment, Victor adds the Comment as an Attribute to the Event that follows.
For the primary (playback) Event, the appropriate Attributes and Links are set based on the information provided by the scheduling system:
Attributes are set for the Duration of the Event and any related metadata such as the Rating (Classification) of the Event.
A Link is created to the corresponding Essence, which is created if it does not already exist. The Essence has a Track that indicates that it is a primary Video and Audio (VA) source.
If the Event is an event which is subsidiary to a preceding Event (also known as a secondary or offset Event), a Child Event is created with a Timing Link that defines the timing relationship between the two events (for example, Start-Start with Offset). The Child Event is created with a link to the corresponding Essence (such as the name of the super). The Track(s) of the associated Essence will likely indicate that it is a Video- (or Audio-) Over event.
If the schedule contains additional information associated with the Event, such as a Subtitle filename or EPG information, then Victor looks for adjacent Events which share the same information. If Victor finds such Events, then it creates a parent event with the common information rather than repeating it for each individual Event. This Event will have associated Essences with Tracks that indicate that they provide EPG or Captioning information.

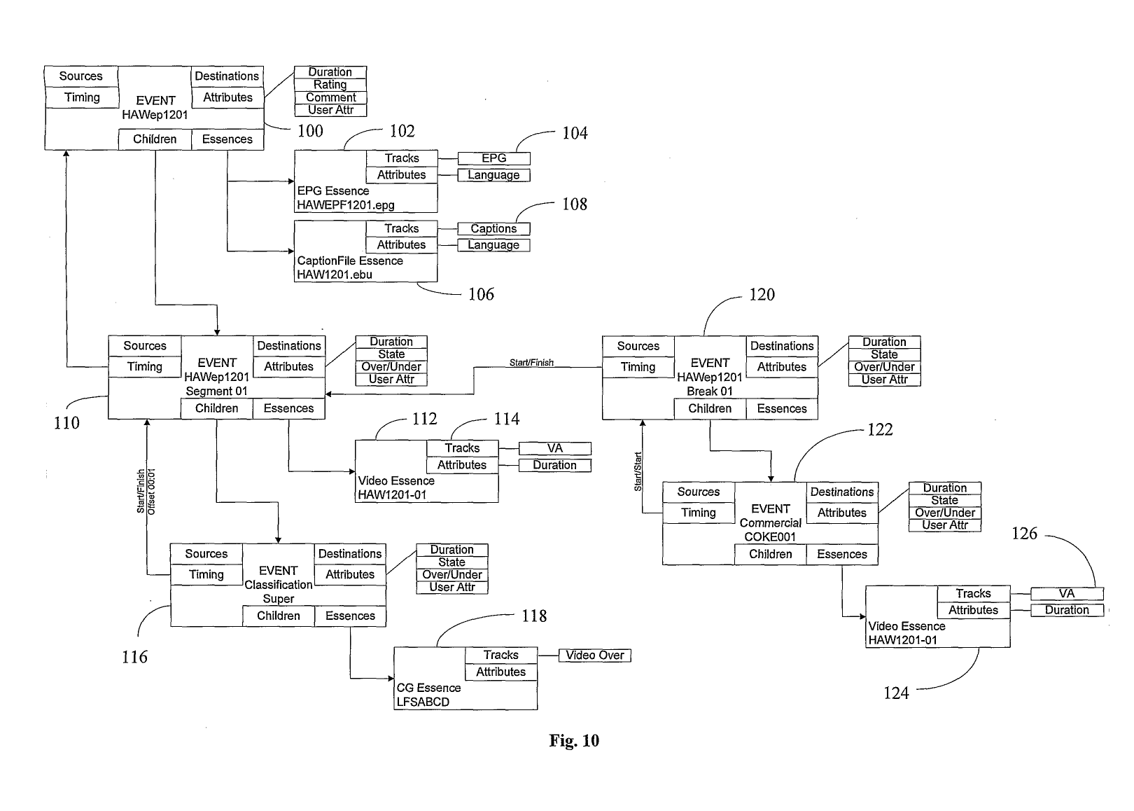

FIG. 10 is a hierarchical representation of the database once an Event has been linked in. In this case, the event is an episode of Home and Away 100. The Event 100 has two linked Essences: The EPG Essence 102 having Track 104 and Caption Essence 106 having Track 108.

The Event 100 also has a child Event 110 which is the first segment of the episode. The timing information shows that Events 100 and 110 are to start at the same time. It has its own Essence 112 having it's own Track 114 that shows that it is VA.

This child Event 110 also has its own child event 116 that is timed to begin 10 seconds after Event 110 has started. The Essence 118 indicates that this Event 116 is the VO.

Following the rules of inheritance described above, since Event 110 has none of it's own EPG information it is instead inherited from Event 100 above. This will cause EPG 104 to be available when the first segment of the episode is played. Similarly, caption 108 will also be displayed.

Event 120 is the commercial break between the first and second segments of the episode. The timing information shows that it starts once the segment of Event 110 is finished. This Event 120 has a child Event 122 that defines the first commercial of the commercial break. The Event 122 has the Essence 126 that shows that the commercial is a VA.

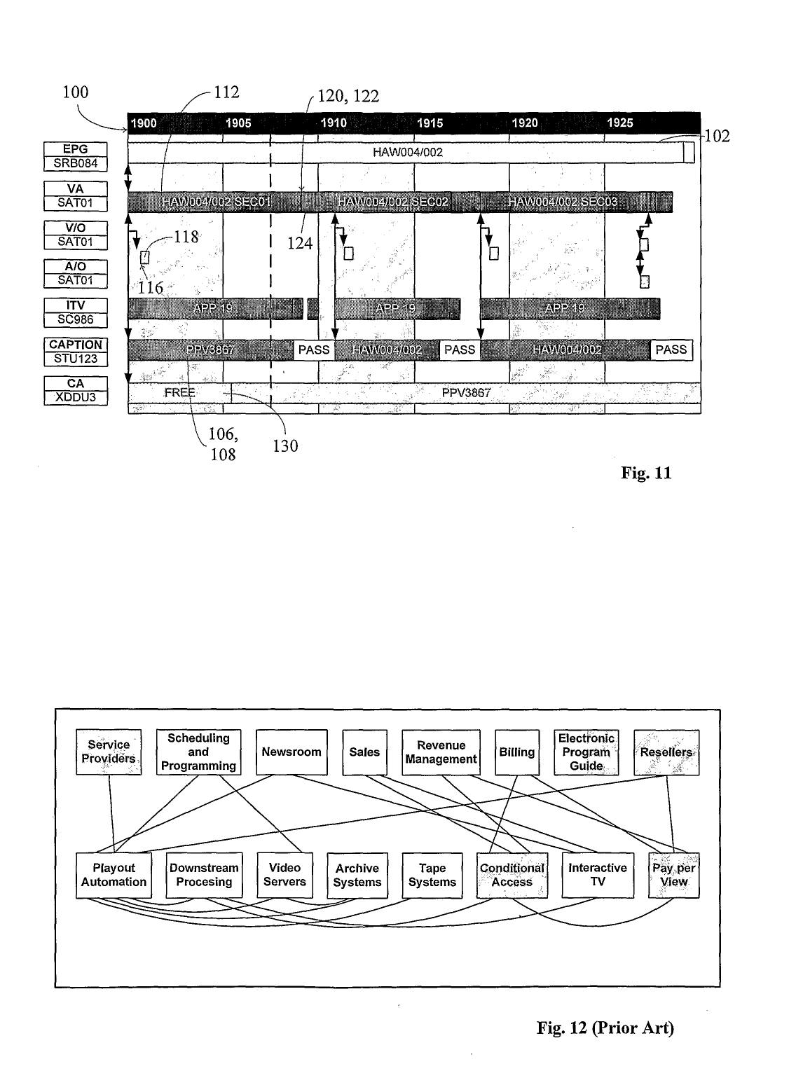

The same information can also be represented “flattened” as shown in FIG. 11. The same reference numerals have been used on FIGS. 10 and 11 to represent the same Event and Essences.

Following the workflow, Victor checks for “implied deletes” in the file that has been received: If an Event was previously in the advance schedule for a particular channel, but is no longer present, then Victor recognises this as a delete and removes the corresponding Event record(s) from the Victor database.

This describes just one example of how Victor can build a hierarchical Event structure from a “flat” traffic file. In practice, this is done in different ways depending on the format and structure of the data that is supplied by the specific Traffic system—it can be XML or SOAP or MOS. The key is that regardless of the format supplied by Traffic, the Victor database structure is flexible enough to be able to represent the schedule in a hierarchical format

Once the Event and Essence records have been updated as described above, the various Victor modules evaluate whether any further action needs to be taken as a result of the new information received:

Victor will then update the Playout Automation 100 and EPG systems 102 with any changes that affect them. For example, the EPG system 102 interface operates as follows:

The EPG system interface is configured to knows that it is only interested in the Track called “EPG”. To determine the EPG information that is to be put to air at a particular time, it follows the following procedure: It starts at the top of the Event hierarchy and walks down the tree of Parent/Children event relationships building a “Track Layer Map” of all Events which contain Essences which have an EPG Track. To determine which EPG should go to air at any given moment, a “vertical line” is drawn through the Track Layer Map and whichever Event is the “lowest” event which also crosses the line provides the required EPG information. FIG. 11 illustrates this procedure:

The database of Victor can be based on MySQL Professional using InnoDB tables. This provides:
A fully ACID high-performance database solution
The ability to scale the database from as small as embedded within the application server, up to a cluster of many replicated nodes
Easy access to the database from third-party tools and applications including ODBC, JDBC (Java), Perl, PHP, and .NET.
The ability to implement the database server on QNX, Sun, Linux or Windows platforms as dictated by performance requirements and customer preference
A comprehensive set of graphical tools for monitoring and administering the database

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of creating a schedule of events for use by a broadcast management system, the method comprising the steps of:
creating an entry for an event of the schedule and associating with the event a first essence and/or a first source of the event;
creating an entry for a sub-event of the schedule and associating the sub-event with the event as a child of the event, and if required, associating with the sub-event a second essence and/or a second source of the sub-event;
if the second essence is not the same type as the first essence or no second essence is associated with the sub-event, the sub-event inheriting the first essence; and if the second source does not support the same essence type as the first source or no second source is associated with the sub-event, the sub-event inheriting the first source.

2. A method according to claim 1, wherein the method further comprises associating with the event or sub-event multiple essences.

3. A method according to claim 1, wherein the essence is any single unit of content, a device of the broadcast management system or a schedule.

4. A method according to claim 1, wherein the essence type is the nature of the content, including a video and audio (VA) type essence, electronic program guide (EPG) type essence, and subtitle type essence.

5. A method according to claim 1, wherein the event is any component of the schedule, and the sub-event is a sub component of the event.

6. A method according to claim 1, wherein the method further comprises managing the broadcast of the schedule by playing to air the event in accordance with the schedule by sourcing the first essence from the first source, and causing the first essence to be played to air.

7. A method according to claim 1, wherein the first essence is inherited by the sub-event and the method further comprises managing the broadcast of the schedule by playing to air the sub-event in accordance with the schedule by causing the first essence to be played air.

8. A method according to claim 1, wherein the method further comprises managing the broadcast of the schedule by performing a transfer of the event in accordance with the schedule by sourcing the first essence from the first source and transferring the first essence to a destination location associated with the event.

9. A method according to claim 1, wherein the first source is inherited by the sub-event, and the method further comprises managing the broadcast of the schedule by performing a transfer of the sub-event in accordance with the schedule by sourcing the second essence from the first source.

10. A method according to claim 1, the method further comprises the step of associating with the event a first destination of the event, and if required, associating with the sub-event a second destination of the sub-event, and if second destination does not support the same essence type as the first destination or no second destination is associated with the sub-event, the sub-event inheriting the first destination.

11. (canceled)

12. A method according to claim 1, wherein the method further comprises the step of associating with the essence a store where the essence is stored, such as a video server or a video cart.

13. (canceled)

14. A method according to claim 1, wherein the method further comprises the step of creating a timing relationship between the event and sub-event.

15-24. (canceled)

25. A datastore for storing a schedule of events for use by a broadcast management system, the datastore comprising:
an entry for an event of the schedule including an associated first essence and/or a first source of the event;
an entry for a sub-event of the schedule that is associated with the event as a child of the event, and if required including an associated second essence and/or second source of the sub-event;
wherein if second essence is not the same type as the first essence or no second essence is associated with the sub-event, the entry of the sub-event including the first essence by inheritance from the event; and if the second source does not support the same essence type as the first source or no second source is associated with the sub-event, the entry of the sub-event including the first source by inheritance from the event.

26-42. (canceled)

43. A method of broadcasting a schedule by a broadcast management system, the method comprising the steps of:
creating the schedule according to the method of claim 1 and storing it in a datastore; and
providing an interface to the datastore to enable a device of the broadcast management system to access the datastore so that the device can extract from the schedule the event and sub-event required by the device to broadcast the schedule.

44-46. (canceled)

47. A software application program installed on a computer system to perform the method according to claim 1.

48. A computer system having processing means and a datastore, wherein software is installed on the computer system to operate the processing means to enable the creation of a schedule according to the method of claim 1 and to store the schedule on the datastore.

49. A computer system according to claim 48, wherein the computer system further comprises a display device to display a visual presentation of the schedule and the visual presentation comprises displaying the schedule as a hierarchical tree of parent and child events.

50. (canceled)

51. A computer system according to claim 49, wherein the computer system further comprises a display device to display a visual presentation of the schedule and the visual presentation comprises displaying the schedule as a grid having duration along one axis and essence type along the other, and every location on the grid being a unique combination of time and essence.

52. A computer system according to claim 49, wherein the computer system further comprises a display device to display a visual presentation of the schedule wherein a first type of visual presentation comprises displaying the schedule as a hierarchical tree of parent and child events, and a second type of visual presentation comprises displaying the schedule as a grid having duration along one axis and essence type along the other, wherein the processing means is operable to cause the display device to alternate the visual display between the two types of visual displays.

53. A software application program installed on a computer system to perform the method according to claim 43.
